(19) United States
(12) Patent Application Publication
(10) Pub. No.: US 2017/0247107 A1
(43) Pub. Date: Aug. 31, 2017

(54) ROTARY-WING VEHICLE AND SYSTEM

(71) Applicant: GeoScout, Inc., Jamaica Plain, MA (US)

(72) Inventors: Istvan Hauer, Jamaica Plain, MA (US); Cyril Blank, Cambridge, MA (US); Allan Vaitses, Marion, MA (US)

(73) Assignee: GeoScout, Inc., Jamaica Plain, MA (US)

(21) Appl. No.: 15/056,408

(22) Filed: Feb. 29, 2016

(51) Int. Cl. B64C 39/02; B64C 27/12; B64D 35/06; B64C 27/08

(52) U.S. Cl. CPC B64C 39/024; B64C 27/08; B64C 27/12; B64D 35/06

(57) ABSTRACT

An apparatus comprising a body defining a first vertical axis, two or more frame members each having a longitudinal axis and having an inner-end and an outer-end connected to the body at the inner-end and where a first horizontal geometrical plane is generally coincident with the longitudinal axis of each of the two or more frame members and where the first horizontal geometrical plane is generally orthogonal to the first vertical axis, two or more rotary-wings each comprising one or more blades whose rotation defines a first rotational axis which is configurable to be nearly parallel with the first vertical axis and comprising a second rotational axis which is configurable to be approximately parallel first horizontal geometrical plane where a first of the two or more rotary-wings having a blade-inner-end and a first blade-outer-end rotatably connected by its blade-inner-end to a first transmission is disposed substantially on the outer-end of a first of the two or more frame members, a second of the two or more rotary-wings having a blade-inner-end and a blade-outer-end rotatably connected by its blade-inner-end to a second transmission is disposed substantially on the outer-end of a second of the two or more frame members, where each of the first rotational axes is disposed on the opposite side of plane which is coincident with the first vertical axis, where the direction of rotation of a first of the two or more rotary-wings about its first rotational axis is opposite of that of the second of the two or more rotary-wings about its first rotational axis, and, where the rotational disk defined by the rotation of the blade-outer-end of the first of the two or more rotary-wings is at least partially coincident with rotational disk defined by the rotation of the blade-outer-end of the second of the two or more rotary-wings.

### CROSS-REFERENCE TO RELATED APPLICATIONS

None.

### FIELD OF THE INVENTION

This disclosure relates to the field of powered vehicles utilizing multiple rotary-wings for lift, orientation control, or propulsion in a fluid medium. More specifically, this disclosure relates to vehicles having one or more sets of counter-rotating rotary-wings, where at least two rotary-wings are mechanically driven by a shared power source, and the rotary-wings are controlled in angle of incidence.

### BACKGROUND OF THE INVENTION

The field of powered vehicles utilizing multiple rotary-wings for lift and propulsion in a fluid medium has seen explosive growth since around 2009. Multi-rotor vehicles can operate in fluid gas or liquid media, or near boundary conditions between fluid media and solid surfaces. Terrestrial variants of such vehicles operating in air exist across the full range of scales, from tiny toy drones to crewed heavy lift helicopters. These vehicles have tremendous utility in that, among other things, they are highly maneuverable and may carry payloads at zero translational speed up to speeds comparable with the speed of slower fixed wing vehicles in the same fluid medium. For example, a particular helicopter's airspeed operating range may start at zero and end above the stall speed of an airplane that could carry a similar payload. If performance characteristics such as load capacity, maximum speed, and endurance were similar; the ability to operate at very low speeds would make the rotary-wing vehicle superior for many missions.

Perhaps the most visible and rapid growth in the field of rotary-wing vehicles has been among very small unmanned remotely piloted vehicles commonly referred to as “drones,” and often described by the Federal Aviation Administration as Unmanned Aerial Systems (“UAS”). In order to have such aircraft, computation systems and sensors must be small, lightweight and have low power consumption. Until the mid to late 2000's, such computation systems and sensors with the required accuracy and multiple sensing axes were not available in the commercial and hobby markets, and were practicable only in larger aircraft or exotic systems such as military devices. The advent of cheap, lightweight, solid state micro-electrical mechanical near-equivalents providing multiple sensing axes consuming milliwatts changed the field.

Recent drone development was enabled by the availability of small, cheap and lightweight solid-state gyro systems and improvements in battery technology. By coupling cheap and lightweight solid-state gyros, cheap and lightweight computing power, and high-energy density batteries, it has become possible to build self stabilizing vehicles with sufficient endurance and lifting capacity to carry payloads on non-trivial missions.

The most common of these missions is the use of a small drone for imagery collection. The vehicles used this way typically employ fixed-pitch rotary-wings, which are disposed generally symmetrically about a central axis, where each fixed-pitch rotary-wing is rigidly mounted coaxially to the drive shaft of an electric motor, and is directly driven by that electric motor. Attitude and acceleration control about all axes is typically achieved by varying the speed of the motors. To increase lift, the rotational speed of the motors is increased in unison. To provide acceleration along or about an arbitrary axis, the rotational speed of the motors is varied differentially. Stability is commonly achieved by incorporating the output of a solid-state gyro in to a Proportional Integral Control (“PID”) system.

The direct drive, fixed pitch arrangement is mechanically simple and inexpensive at the cost of various inefficiencies and limitations. Examples of the costs of this configuration include:
1. The entire area of a rotor's rotational coverage must be fully separated from all the other rotors, limiting the geometry of the vehicle and limiting the ratio of the effective rotor disk area to a relatively low fraction of the vehicle's overall footprint.
2. The use of fixed pitch rotors limits the efficiency and operating conditions of the vehicle because the angle of attack of the rotor blades cannot be controlled thus requiring the rotors to often be operated away from their best Lift/Drag angle of attack.
3. Because the electric motors cannot be operated at a constant peak efficiency RPM, the motors are often operated at reduced efficiency.
4. To increase speed or payload, the only options are to increase the output of the electric motors (which generally requires increasing the mass of the motors), adding motors (accruing additional conversion losses), or increasing the rotor-blade size (further limiting the maneuverability of the vehicle because the rotational moment of inertial of the vehicle and the blade increases, and requiring a larger vehicle footprint).
5. Unless a complex mechanical transmission was used to vary rotor speeds, it is not possible to use a centralized electrical motor to, among other reasons, decrease energy conversion losses.
6. If all electrical power is lost, the vehicle will crash because (unlike other rotary-wing aircraft) it is not possible to auto-rotate this kind of configuration.
7. If an electrical motor failure occurs, the vehicle may be rendered uncontrollable.
8. The provision of redundant mechanical power sources is impracticable because rotors are directly connected to the electrical motor shafts.
9. The use of internal combustion engines burning high energy density liquid fuel to ultimately power multiple electric motors is impractical or requires multiple conversion losses (due to electrical generation, storage inefficiencies, etc.) limiting the endurance, payload and range of multi-electric motor drones.

As a result of these costs, low-end drones that have an easily transportable footprint are typically electric and have a payload capacity less than five pounds and endurance of less than 30 minutes at a maximum speed around 35 miles per hour. A higher-end electric drone, such as the MicroDrones MD4-3000 has better performance, having a payload capacity of 6 to 9 pounds, a range of up to 15 miles, and endurance of about 45 minutes at a maximum speed of about 36 miles per hour. This performance is still inadequate for many potentially important commercial and industrial applications, thus designers turn to internal combustion engines to provide more power. Exemplary internal combustion powered rotary-winged vehicles have dramatically higher payload capacities ranging from about 35 to 110 pounds, generally better range, endurance, and because excess power is more available for a longer time than battery powered vehicles, a higher real world typical operating speed. Moreover, excess thrust from engine exhaust may be used to increase performance. However, these improvements have tended only to be available in larger vehicles of dramatically greater weight and cost. Moreover, these vehicles tend to be large enough that a truck must transport them. In contrast, most electric drones can be easily carried by hand. The following table summarizes the typical characteristics of battery electric powered UAS vehicles versus typical liquid fuel internal combustion UAS vehicles:

| | Battery Powered UAS | Liquid Fuel Powered UAS |
|---|---|---|
| Footprint | <1 ft to 6.5 ft diam. | 9 to 10 ft length or diam. |
| Weight | <1 lb to 33 lbs | 200 to 440 lbs |
| (max) | | |
| Payload | <1 lb to 6-9 lbs | 25 to 110 lbs |
| Endurance | <30 min to 45 min | 1 to 10 hrs |
| Range | <2 miles to 30 miles | 25 to 600+ miles |
| Max Speed | ~35 MPH to 36 MPH | 25 to 110 MPH |
| Rotors # | 2 to 6 | 2 |
| Power | Small Battery to 290 W-Hr | Turbine or Reciprocating |
| | LiPo Battery | |
| Transport | Hands to Truck | Truck |
| Cost | <$1K to >$50K | $86K to $400K |

Some exceptions to these typical ranges are said to exist in marketing literature, such as the 17.5 pound claimed payload capacity of the Airnamics R5 Electric drone.

The table illustrates various problems with the current state of the art. For examples:
Commercially relevant payloads comprise remote sensing systems cameras, including multi-spectral sensors, thermal sensors, Lidar, to name a few. However, There is a distinct lack of vehicles smaller than 9 feet in length or diameter and less than about 200 pounds, which are able to carry payloads in the commercially desirable range from 10 to 30+ pounds. Larger vehicles require dedicated transportation and handling crews.
While it is well known that increasing the number of rotors can improve vehicle stability, there is a lack of multi-rotor vehicles with a high power to weight ratio. To get a good payload, the current state of the art is strongly biased to heavier vehicles having fewer rotors. There is a lack of compact stable vehicles able to handle applications with dense destabilizing payloads, such as chemical applications or weapons systems.
There is also a distinct lack of small vehicles having a range greater than about 30 miles and endurance of more than 45 minutes, which are parameters needed to support numerous commercial and governmental mission profiles.
While liquid fuel provides the potential for greater payload, range and speed, present liquid fueled UAS vehicles are much larger than battery powered vehicles.
Compact, high rotor disc loaded vehicles are not available. Such vehicles would be more stable in turbulence and able to carry heavier loads than now feasible in restricted areas.
Vehicles with direct motor driven rotors cannot be configured with redundant power supplies and may become unstable if a motor fails.
Vehicles with direct motor driven rotors are not capable of auto-rotation in the event of motor failure or power supply interruption.

Known in the art is Achtelik et al., U.S. Pat. No. 9,051,050, which is said to disclose a rotary-wing aircraft, comprising at least four rotors, which are disposed on girder elements, wherein said rotors and girder elements are disposed such that a free field of vision is defined along a longitudinal axis of said rotary-wing aircraft at least between two terminal rotors

Also known in the art is Christensen et al., U.S. Pat. No. 9,061,763, which is said to disclose a radio controlled model rotorcraft implemented with features improving ease of flight and flight performance by increasing structural stability, increasing rotorcraft visibility and orientation awareness through the use of multifunctioning, configurable, and aesthetically pleasing components, while also increasing resistance to damage from crashes through use of impact and vibration absorbing components.

Also known in the art is Cutler, “Design and Control of an Autonomous Variable-Pitch Quadrotor Helicopter,” submitted to the Department of Aeronautics and Astronautics in partial fulfillment of the requirements for the degree of Master of Science in Aeronautics and Astronautics at the MASSACHUSETTS INSTITUTE OF TECHNOLOGY September 2012 which is said to disclose that the aerospace community, particularly in academia, has seen a recent rise in the popularity of fixed-pitch quadrotor helicopters. The fixed-pitch quadrotor is popular largely because of its mechanical simplicity relative to other hovering aircraft. This simplicity, however, places fundamental limits on the achievable actuator bandwidth and the types of maneuvers possible to fly. This thesis explores the extent to which the addition of variable-pitch propellers to a quadrotor helicopter overcomes these limitations. A detailed analysis of the potential benefits of variable-pitch propellers over fixedpitch propellers for a quadrotor is presented. This analysis is supported with experimental testing to show that variable-pitch propellers, in addition to allowing for efficient generation of negative thrust, substantially increase the maximum rate of thrust change. A nonlinear, quaternion-based control algorithm is presented for controlling the quadrotor. An accompanying trajectory generation method is detailed with an optimization routine for finding minimum-time paths through waypoints. The control law and trajectory generation algorithms are implemented in simulation and on a custom variable-pitch quadrotor. The quadrotor attitude control is performed on the vehicle using a custom autopilot. Position and attitude measurements are made with an off-board motion capture system. Several flight tests are shown with a particular emphasis on the benefits of a variable-pitch qaudrotor over a standard fixed-pitch quadrotor for performing aggressive and aerobatics maneuvers. To the best of the Cutler's knowledge, this work marks the first documented, autonomous variable-pitch quadrotor built for agile and aggressive flight.

Also known in the art is Dragon et al., U.S. Patent Application Publication No. 2010/0044499, published Feb. 25, 2010, which is said to disclose rotary wing aircraft is provided having at least three rotor pairs. Each rotor pair has an upper rotor and a lower rotor. During operation, the upper rotor and lower rotor rotate around a shared rotor axis with the upper rotor rotating in a first direction and the lower rotor rotating in an opposite direction By independently controlling the speed of rotation of each upper rotor and each lower rotor the aircraft can be made to ascend, descend, move forward, move backward, move side to side, yaw right and yaw left by only varying the relative speeds of rotations of the upper rotors and lower rotors.

Also known in the art is Fernandes, U.S. Pat. No. 4,818,990, which is said to disclose a monitoring system using a unique remotely piloted drone with dual counter rotating propellers and carrying electric field sensing, thermal infra-red imaging, video imaging, acoustic and corona discharge sensing equipment. The compact remotely piloted drone flies along a power corridor and is maintained at a fixed distance from an outer phase conductor using on board electric field detection circuitry, video/infra-red imagery and an RF/laser altimeter. The counter rotating, twin-turbo driven configuration for the propellers mounted on coaxial vertical shafts provides a highly stable platform, unlike conventional manned helicopters presently used for routine right-of way patrols. Dual, counter-rotating saucer-shaped auxiliary propellers provide a degree of stability far superior to a conventional helicopter, particularly in gusty winds. On board sensors and video cameras would permit electric utilities an economic approach to right of-way monitoring, inspection of frayed conductors or deteriorated splices through infra-red sensing, detection of cracked insulators through acoustic/corona sensors, monitoring of critical, thermally limiting spans and other monitoring functions.

Also known in the art is Goodarzi, U.S. Pat. No. 8,561,937, which is said to disclose an unmanned aerial vehicle comprising a hemispherical body, a brushless type electrical, a propeller, a plurality of wingtip devices, a plurality of servo motors and each of the plurality of the servo motors is connected to each of the plurality of the wingtip devices respectively, a plurality of carbon rods, and a casing. The brushless type electrical motor provides a lifting force for a vertical take-off and landing (VTOL) and the plurality of wing tip devices are classified into three types of wing tip devices and the three types of wing tip devices are controlled by the respective servo motors to control yaw, pitch and roll movements thereby stabilizing and controlling the movement of an aircraft.

Also known in the art is Kalantari et al., U.S. Pat. No. 9,150,069 which is said to disclose a vehicle capable of both aerial and terrestrial locomotion. The terrestrial and aerial vehicle includes a flying device and a rolling cage connected to the flying device by at least one revolute joint. The rolling cage at least partially surrounds the flying device and is free-rolling and not separately powered.

Also known in the art is Keennon et al., U.S. Pat. No. 9,199,733, which is said to disclose a rotorcraft including a fuselage, one or more motor-driven rotors for vertical flight, and a control system. The motors drive the one or more rotors in either of two directions of rotation to provide for flight in either an upright or an inverted orientation. An orientation sensor is used to control the primary direction of thrust, and operational instructions and gathered information are automatically adapted based on the orientation of the fuselage with respect to gravity. The rotors are configured with blades that invert to conform to the direction of rotation.

Also known in the art is Kerr, U.S. Pat. No. 4,478,379, which is said to disclose an unmanned aircraft of the remotely piloted type that is characterized by its configuration and outline using rigid counter rotating propellers, positioned substantially at the height of its center of mass or slightly below to allow producing a sufficiently large control moment to use a tether line for landing the aircraft and to allow using two substantially spheroidal surfaces at the top and bottom respectively rather than a single one relatively larger and more detectable surface as when the propellers are at the top.

Also known in the art is Kroetsch et al., U.S. Pat. No. 8,322,648, which is said to disclose a hovering aerial vehicle with removable rotor arms and protective shrouds. Removing the shrouds reduces the weight of the vehicle and increases flight time. Removing the rotor arms makes the vehicle easier to transport. Removable rotor arms also simplify field repair or replacement of damaged parts.

Also known in the art is Lissaman et al., U.S. Pat. No. 5,070,955, which is said to disclose a flight system capable of passively stable hover and horizontal translatory flight, comprises an apparatus defining a vertical axis, and including multiple ducts with substantially vertical axes in hover mode, spaced the axis; fluid momentum generators in the ducts to effect flow of fluid downwardly in the ducts in hover; and fluid flow deflector structure in the path of the flowing duct fluid, and angled to deflect the fluid flow away from the axis, in such manner as to provide stability in hover of the apparatus, as well as stability when the entire device is tilted through approximately 90° to execute horizontal translatory flight.

Also known in the art is Marcus, U.S. Pat. No. 8,973,862, which is said to disclose an aerial vehicle includes independently controlled horizontal thrusters and vertical lifters to provide design and operational simplicity while allowing precision flying with six degrees of freedom and use of mounted devices such as tools, sensors, and instruments. Each horizontal thruster and vertical lifter can be mounted as constant-pitch, fixed-axis rotors while still allowing for precise control of yaw, pitch, roll, horizontal movement, and vertical elevation. Gyroscopes and inclinometers can be used to further enhance flying precision. A controller manages thrust applied the horizontal thrusters and vertical lifters to compensate for forces and torques generated by the use of tools and other devices mounted to the aerial vehicle.

Also known in the art is Millea et al., U.S. Pat. No. 6,672,538, which is said to disclose a transmission system for a hybrid aircraft is driven by a plurality of driveshafts and drives a translational propulsion system. Each driveshaft is mounted to a pinion gear which mesh with an upper and lower counter-rotating gear. The upper and lower counter-rotating gears drive a respective upper and lower rotor shaft which powers a counter-rotating rotor system. A first angle is defined between a first and a second driveshaft while a second angle is defined between the second and a third driveshaft. The angle between the driveshafts are a whole number multiple of the formula: θ=(CP/R)*(180/π). By so angularly locating the driveshafts, proper meshing of the pinion gears and the upper and lower counter-rotating gears is assured and tolerances are less stringent as the support structure is effective designed around optimal location of the driveshafts for gear meshing rather than vice versa.

Also known in the art is Moller, U.S. Pat. No. 4,795,111, which is said to disclose a flying platform, propelled by at least one ducted fan causing a vertically downwardly directed airstream in and through a cylindrical duct. A vane system in the duct has two mutually perpendicular pairs of diametrically opposite first vanes, each extending in from the duct rim toward the center of the duct. Each pair of first vanes provides a pair of generally vertical walls parallel to a diametral line across the duct, and they define duct passages between the pairs of vanes and define quadrants between adjacent pairs. Each first vane has an upper, fixed, rigid portion and a variable camber flap depending therefrom. A first servomotor with linkages vary the camber of each pair of flaps, so that the camber of the flaps of each pair is at all times the same amount but in opposite directions. Preferably, there are also four second vanes, one bisecting each quadrant, and a symmetric pair of spoilers is mounted on each second vane. Each pair of spoilers is independently movable, as a pair continuously between a position substantially blocking airflow through the outer portion of said quadrant and a position permitting substantially full airflow therethrough. A second servomotor with linkages symmetrically varies the position of its spoilers. There may be a radio receiver responsive to remote control signals for actuating each servomotor and its linkages.

Also known in the art is Oakley et al., U.S. Pat. No. 8,774,982, which is said to disclose a helicopter having a modular airframe, with multiple layers which can be connected easily, the layers which house the electronics (autopilot and navigation systems), batteries, and payload (including camera system) of the helicopter. The helicopter has four, six, and eight rotors, which can be easily changed via removing one module of the airframe. In one embodiment, the airframe has a vertical stacked appearance, and in another embodiment, a domed shape (where several of the layers are stacked internally). In one embodiment, there is a combination landing gear and camera mount. The helicopter allows for simple flight and usage by remote control, and non-remote control, users.

Also known in the art is Shaw, U.S. Pat. No. 9,187,174 which is said to disclose a flight vehicle, and methods of operation thereof, having wings and movable propeller assemblies which can be rotated to provide vertical and/or horizontal thrust. The propeller assemblies are configured to maximize available engine/propeller thrust and to prevent propwash from striking the wings of the aircraft.

Also known in the art is Smitherman et al., U.S. Pat. No. 7,127,348, which is said to disclose a vehicle based data collection and processing system which may be used to collect various types of data from an aircraft in flight or from other moving vehicles, such as an automobile, a satellite, a train, etc. In various embodiments the system may include: computer console units for controlling vehicle and system operations, global positioning systems communicatively connected to the one or more computer consoles, camera array assemblies for producing an image of a target viewed through an aperture communicatively connected to the one or more computer consoles, attitude measurement units communicatively connected to the one or more computer consoles and the one or more camera array assemblies, and a mosaicing module housed Within the one or more computer consoles for gathering raw data from the global positioning system, the attitude measurement unit, and the retinal camera array assembly, and processing the raw data into orthorectified images.

Also known in the art is Smitherman, U.S. Pat. No. 7,725,258, which is said to disclose a vehicle based data collection and processing system which may be used to collect various types of data from an aircraft in flight or from other moving vehicles, such as an automobile, a satellite, a train, etc. In various embodiments the system may include: computer console units for controlling vehicle and system operations, global positioning systems communicatively connected to the one or more computer consoles, camera array assemblies for producing an image of a target viewed through an aperture communicatively connected to the one or more computer consoles, attitude measurement units communicatively connected to the one or more computer consoles and the one or more camera array assemblies, and a mosaicing module housed within the one or more computer consoles for gathering raw data from the global positioning system, the attitude measurement unit, and the retinal camera array assembly, and processing the raw data into orthorectified images.

Also known in the art is Tao et al., Chinese National Patent No. CN 203439256, published Feb. 19, 2014, which is said to disclose a multi-rotor-wing unmanned aerial vehicle for monitoring and tracing pollution gas, which comprises an unmanned aircraft airframe and a plurality of rotor wing components for driving the unmanned aircraft airframe, wherein gas sensors are respectively arranged on the unmanned aircraft airframe in various directions; a GPS positioning module, a power supply, a processor and a flight controller are arranged in a loading cabin at the center of the unmanned aircraft airframe; the GPS positioning module, the power supply and the gas sensors are respectively connected with the processor; the processor is connected with the flight controller. According to the utility model, the gas sensors are arranged on the unmanned aerial vehicle, so that the unmanned aerial vehicle is particularly suitable for monitoring the polluted areas which are low in visibility, the pollution situation of the polluted areas can be comprehensively acquired, and the accurate analysis on the pollution situation of the polluted areas is facilitated.

Also known in the art is Wang et al., U.S. Pat. No. 9,016,617, which is said to disclose methods and apparatus for unmanned aerial vehicles (UAVs) with improved reliability. According to one aspect of the invention, interference experienced by onboard sensors from onboard electrical components is reduced. According to another aspect of the invention, user-configuration or assembly of electrical components is minimized to reduce user errors.

Also known in the art is Zhou et al., U.S. Patent Application Publication No. 2014/0254896, published Oct. 9, 2008, which is said to disclose a system and method for delivering mail and goods using a mobile robot drone system. The method may comprise self-moving the mobile robot drone system to a mail or goods receiving location. Data on the mail or goods receiving location and mail or goods to deliver id received from a user. Itinerary to the mail or goods receiving location is determined based on itinerary data received from a GPS unit. In the location, the mobile robot drone system receives the mail or goods via a mail and goods compartment and then delivers the mail or goods to a predefined location. Based on user instructions, the mobile robot drone system electronically signs receipt verification documents or performs payment by displaying a payment barcode encoding user payment information. After delivering the mail or goods, the mobile robot drone system provides access to the mail and goods compartment.

Also known in the art is the Incredible HQ project (Website: incrediblehlq), which is said to be designing and building a Heavy Lift Quadcopter (HLQ) which we are calling Incredible HLQ (sounds like “Hulk”). Like the super hero, HLQ will be able to lift and transport a huge amount of weight for it's size and cost. HLQ will be capable autonomously retrieving and delivering 50 pounds of payload.

Also known in the art is the Fusion Flight (Website: fusionflight.com) quad jet-engine drone that is said to be powered by four vertically positioned Jet-Engines (Microturbines). Compared to all electrical drones, the JetQuad is capable of 10-fold performance increase due to the high energy density and power output of Kerosene fuel. The JetQuad comes in three distinct models each with a varying fuel capacity: S, L, and XL.

Also known in the art is the Airnamics R5 drone, (Website: airnamics.com) which is said to be the ultimate camera motion system.

It is believed that none of the foregoing art, either alone or in combination, affirmatively addresses the problems discussed above. As a few examples:

There is a need for compact vehicles that can carry commercially relevant payloads, be transported and launched by a single person from a normal car or van.

There is a need for inherently stable vehicles, such as multi-rotor vehicles, capable of absorbing large:
changes in center of gravity or maneuvering payloads with high moments of rotational inertia during a mission, such as chemical applications.
impulse inputs, such as those created by munitions deployment such as a firing a rocket.

There is a need for relatively small UAS vehicles that:
have improved range and loiter capability, and which
are capable of managing dense payloads in relatively confined volumes.

There is a need for rapidly deployable and field refuelable small vehicles, which can support a rapid reconfiguration between heavy payload/short range and medium payload longer range/loiter profiles.

There is a need for a vehicle that can be configured to have a backup power source and is not subject to instability with a single motor failure.

There is a need for a compact vehicle capable of auto-rotation and control in the event of a total drive power failure, especially with hazardous or valuable payloads, or when operating in residential or other sensitive areas.

### SUMMARY OF THE INVENTION

According to one aspect, the invention features a compact high-disc loaded multi-rotor vehicle.

In one embodiment, multiple rotor blades are arranged to intermesh to decrease the surface area of the vehicle's effective rotor disk area while increasing the vehicle's lift density.

In another embodiment, some rotors counter-rotate to decrease and control undesirable torque interactions.

In another aspect, a vehicle is configured to enable the redundant supply of power to rotors.

In yet another aspect, a vehicle is provided that has a separate power supply for its control system.

In still another embodiment, a vehicle is capable of auto-rotation in the event of drive power failure.

In another aspect, the invention features pitch-controlled rotor blades.

In a further embodiment, the vehicle is part of a system comprising refueling stations whereby the vehicle may extend its mission.

In one embodiment there is a vehicle with detachable rotor-arm assemblies.

In another embodiment, there is a vehicle whose frame is an optimized monocoque frame.

In still another embodiment, the invention provides sufficient payload capacity to carry industrial payloads such as multi-spectral sensors, chemical sensors or the like.

According to another aspect, the invention provides a vehicle with range and endurance superior to electrically powered vehicles having a similar volume.

According to yet another aspect, the vehicle is additional stabilized and controlled by employing sensors that provide attitude or acceleration information.

In still another aspect, the vehicle is computer controlled and configured for manual, semi-autonomous or autonomous operation.

In a further aspect, the vehicle is configured to operate beyond the line-of-sight, and may operate using optical, radar or sonar navigation.

In yet another aspect the vehicle may employ long range navigation sensors.

In even a further aspect the vehicle may employ inertial guidance functionality for navigation or stability.

### BRIEF DESCRIPTION OF THE DRAWINGS

The foregoing and other features and advantages of the disclosed subject matter will be apparent from the more particular description of preferred embodiments of the disclosed subject matter, as illustrated in the accompanying figures in which reference characters refer to the same parts, blocks, or elements, throughout the different figures. The figures are of schematic and flowchart nature, where emphasis is placed upon illustrating the principles of the invention.

FIG. 1 (Prior Art) is a photograph of a typical, commercially available multi-rotor battery powered drone.

FIG. 2 (Prior Art) is a photograph of a helicopter with dual non-coplanar intermeshing rotors.

FIG. 3 (Prior Art) is a photograph of a quad-copter featuring individually pitch-controlled blades with direct drive motors.

FIG. 4 (Prior Art) is a photograph of a quad-copter featuring individually pitch-controlled blades with a transmission drive.

FIG. 5 illustrates an isometric view of a vehicle according to the present disclosure.

FIG. 6 illustrates a side view of a vehicle according to the present disclosure.

FIG. 7 illustrates a top view of a vehicle according to the present disclosure.

FIG. 8 is a photograph of a vehicle according to the present disclosure.

FIG. 9 is a side view of a central drive gear unit according to the present disclosure.

FIG. 10 illustrates a vehicle configuration lacking blade overlap.

FIG. 11 illustrates an isometric view of a monocoque frame vehicle according to the present disclosure.

FIG. 12 illustrates a top view of a monocoque frame vehicle according to the present disclosure.

FIG. 13 shows a configuration of power off-take and drive side arm of a vehicle according to the present disclosure.

FIG. 14 illustrates an internal configuration of power take-off and input pinion of a vehicle according to the present disclosure.

FIG. 15 illustrates an embodiment of a power take-off and pinion and a main power-distribution gear.

FIG. 16 illustrates an exemplary pitch control arrangement.

FIG. 17 illustrates an exemplary pitch control sliding mechanism and internal details of a rotor gearbox assembly.

FIG. 18 illustrates an exemplary rotor head.

FIG. 19 illustrates an exemplary thrust bearing pack.

FIG. 20 illustrates an exemplary exchangeable rotor servo subassembly.

FIG. 21 illustrates a payload configuration for a vehicle according to the present disclosure.

FIG. 22 illustrates a refueling arrangement for a system employing a vehicle according to the present disclosure.

FIG. 23 illustrates an exemplary control system for a vehicle according to the present disclosure.

### DETAILED DESCRIPTION

The vehicle of the present disclosure is best understood by reference to the following detailed description that makes use of the accompanying figures.

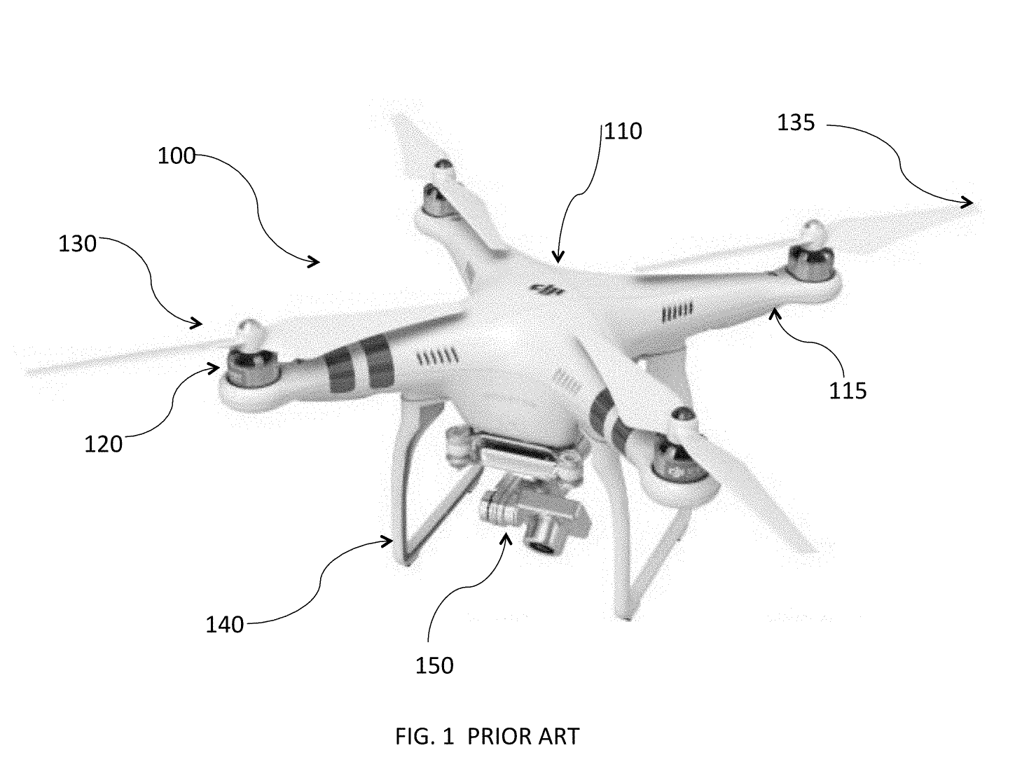

FIG. 1 (Prior Art) is a photograph of a typical, commercially available multi-rotor battery powered drone 100. Such a drone features a fuselage and structural frame 110 with arms 115 extending outward generally symmetrically from a center point. Motive power is supplied by a set, in this case four, motors 120 that are directly attached to fixed pitch rotor blades 130. Control is achieved by driving each motor at a variable speed to alter the lift produced by the corresponding rotor 130. In this kind of design, it is inherent that the rotors 130 must be arranged so as not to have any interference with one another. The benefits of this arrangement include simple construction and allow control to be achieved through the use of electrical power as the RPM of each motor 120 is varied. Opposing rotors 130 are generally rotated counter to one another to eliminate the need for other anti-torque measures. The costs of this arrangement include the inability to control the angle of attack of the rotors 130 and the fact that if a co-planar rotor system is desired, then the disks defined by the sweep of the tips 135 of the rotor 130 blades must not have any overlap, increasing the disk loading of the vehicle. Other features drone 100 that are typical, include fixed landing gear 140, and a payload of a small camera 150.

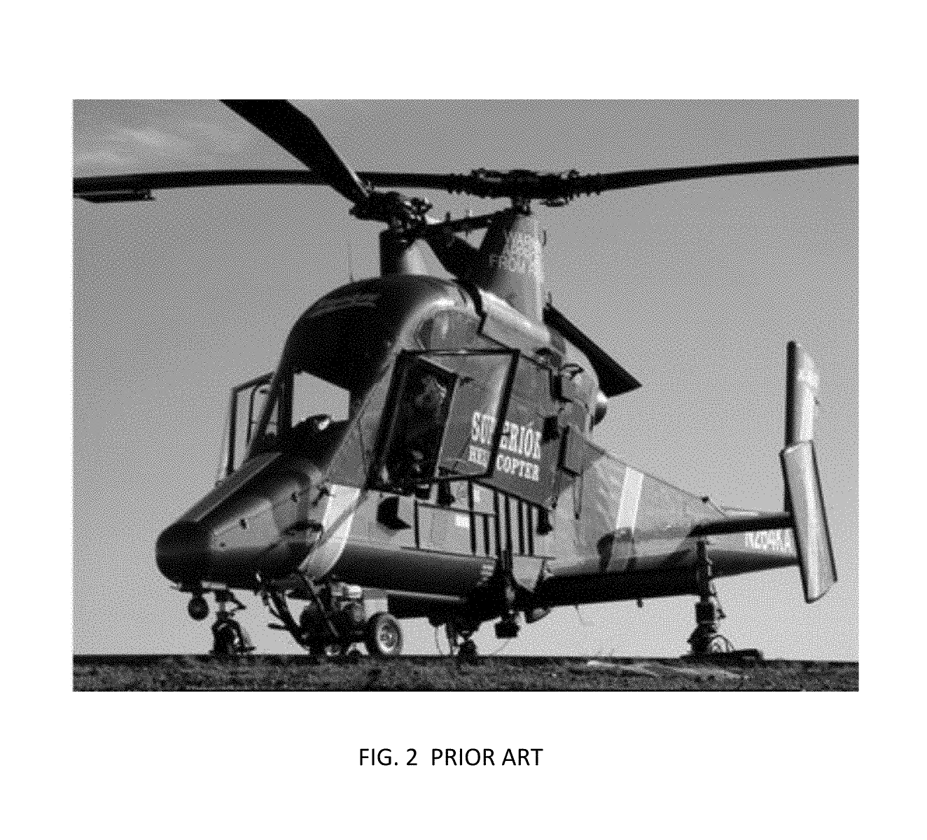

It has been long known (prior to 1950) that employing multiple-rotors such that the rotor disk areas overlap can provide benefits. FIG. 2 (Prior Art) is a photograph of a Kaman K-MAX helicopter with dual non-co-planar intermeshing rotors. As with the typical drone 100, this helicopter employs counter-rotating rotors. The rotors are not coplanar, reducing the efficiency of the rotors. Also, an intermeshing arrangement does not appear to have been employed in UAS vehicles.

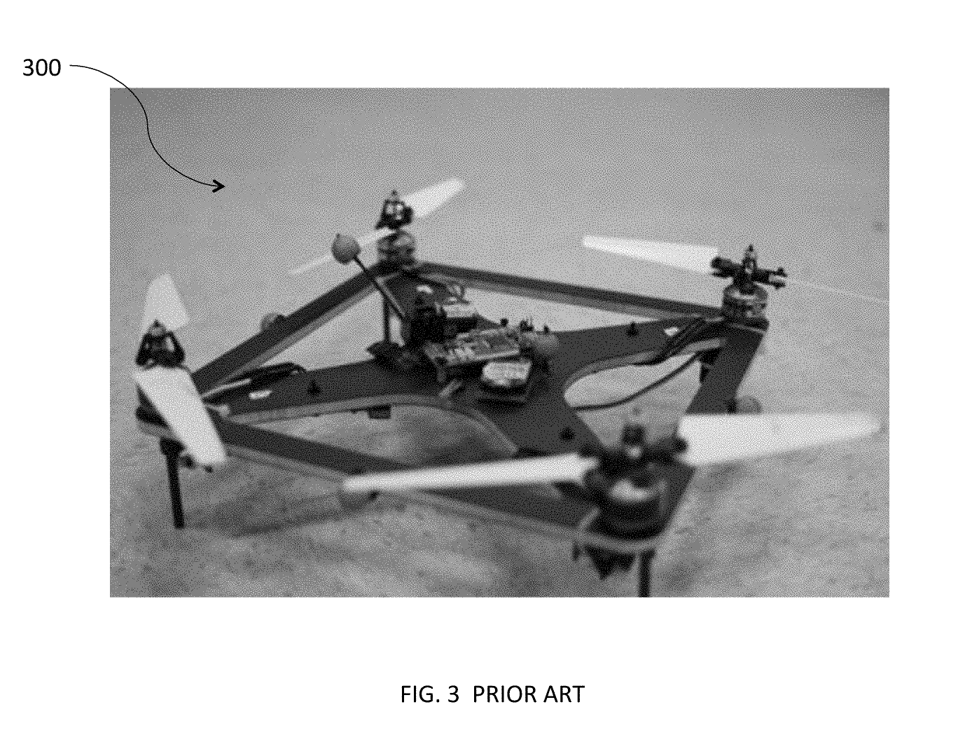

Moreover, the limitations of fixed pitch rotors in UAS vehicles has begun to receive attention in the art. FIG. 3 (Prior Art) is a photograph of an experimental system built by Cutler at the Massachusetts Institute of Technology, which is quad-copter built featuring individually pitch-controlled blades with direct drive motors. Other than adding pitch control to each rotor, this vehicle is similar to drone 100 at least in that direct drive electrical motors and non-overlapping rotors are employed.

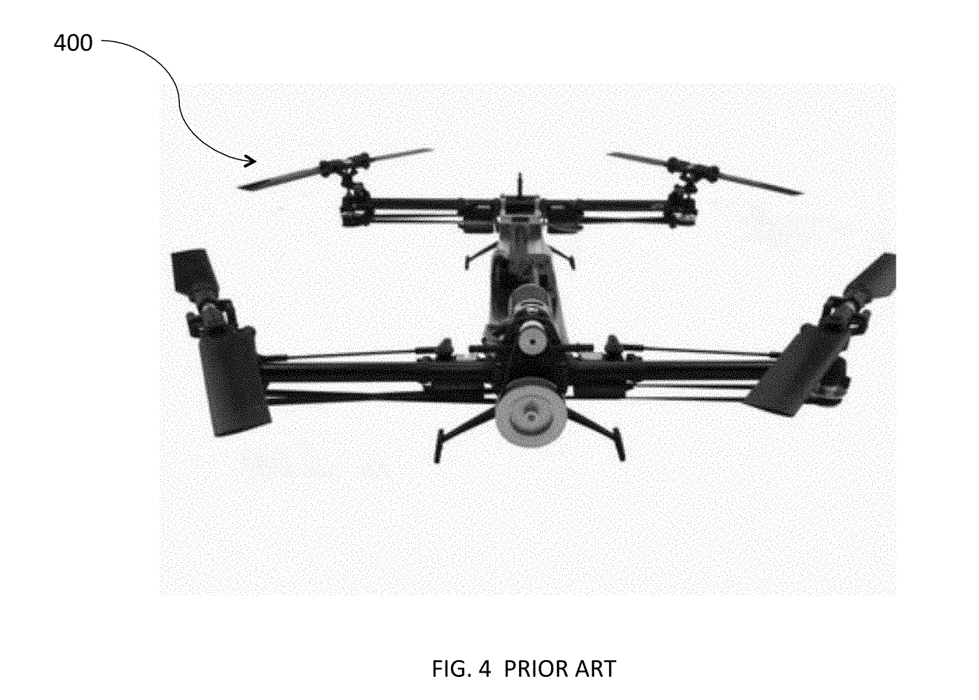

FIG. 4 (Prior Art) is a photograph of a Stingray 500 quad-copter 400 that does not use individual motors to drive fixed-pitch rotors. In this vehicle, power is transmitted to the rotor blade via combination of belts and shafts so that the non-overlapping rotors always rotate at a fixed rate compared to the other rotors. Control is achieved by employing servos to pitch-control each set of blades.

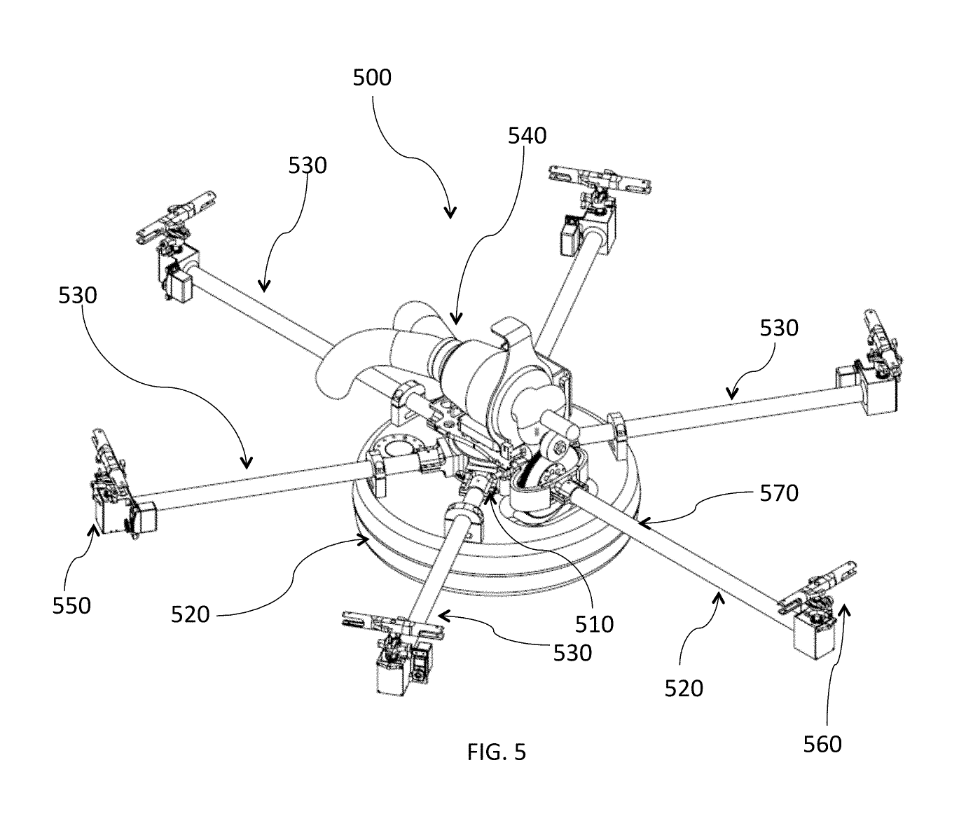

Each of the foregoing vehicles has limitations that would be valuable to overcome. FIG. 5 illustrates an isometric view of an exemplary compact, high performance multicopter 500, illustrated as a hexacopter according to the present disclosure configured to solve a number of these limitations. Though other embodiments have utility, a symmetrical hexacopter configuration is convenient because, among other reasons, that three pairs of counter-rotating rotors naturally provide favorable torque control. However, other configurations with differing sized rotors of any number are feasible provided that the overall torque moments can be balanced out throughout the flight regimes. In some embodiments, the use of different sized rotors may lead to favorable geometry for lowering fluid-dynamic disk loading. The multicopter 500 may employ a central gearbox 510 that serves as part of the vehicle's frame. In this embodiment, a fuel tank 520 is disposed below the main gearbox 510, and may provide additional support for each of the vehicle's arms 530 and 570. In this embodiment, a central mechanical power source 540, such as a gas turbine engine, is mounted in close proximity to main gearbox 510. One or more arms are configured as power take-offs and drive side arms 570 which transmit power from central mechanical power source 540 to central gearbox 510. The more typical arms 530, receive power from the main gearbox 510.

Disposed, in this embodiment, at the end of each arm 530 or 570 is a rotor gearbox assembly 550, which provides for mechanical transmission of power to each rotor hub 560.

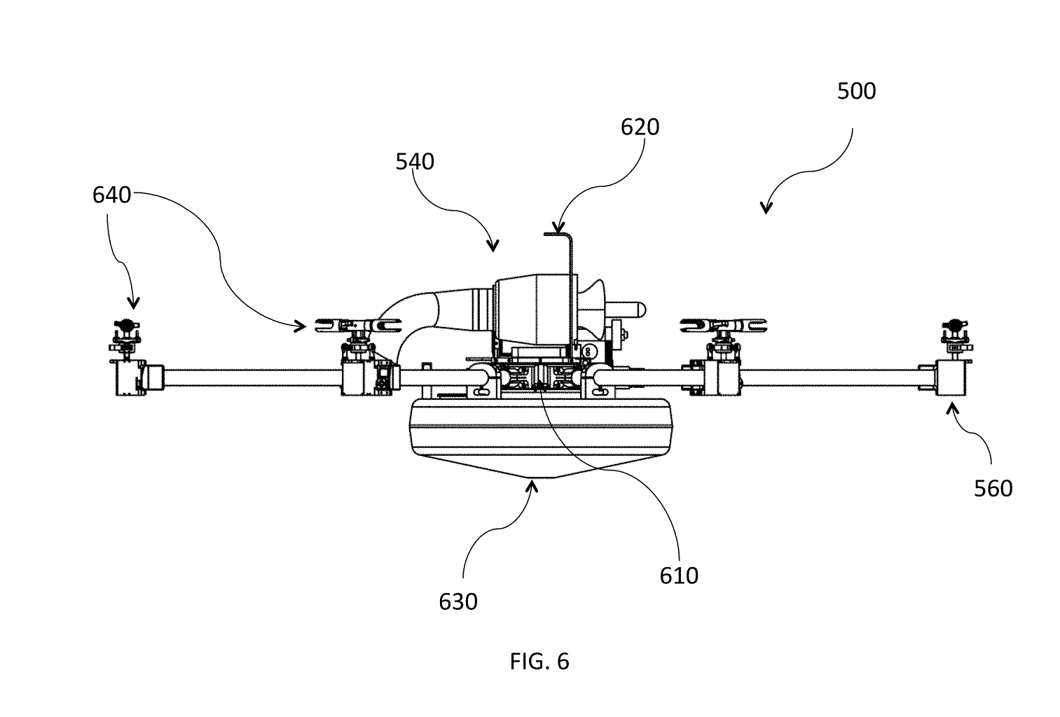

FIG. 6 illustrates a side view of multicopter 500. An electronic vehicle controller 610 may be mounted on the multicopter 500's frame. Provisions, such as bracket 620, for mounting a sensor on the top of the vehicle may be provided. A payload bay or mount 630 may be incorporated. In this example embodiment, payload bay or mount 630 is disposed directly beneath the fuel tank 520. In this embodiment, all rotor hubs 560 are aligned in a single plane, as is evident in FIG. 6.

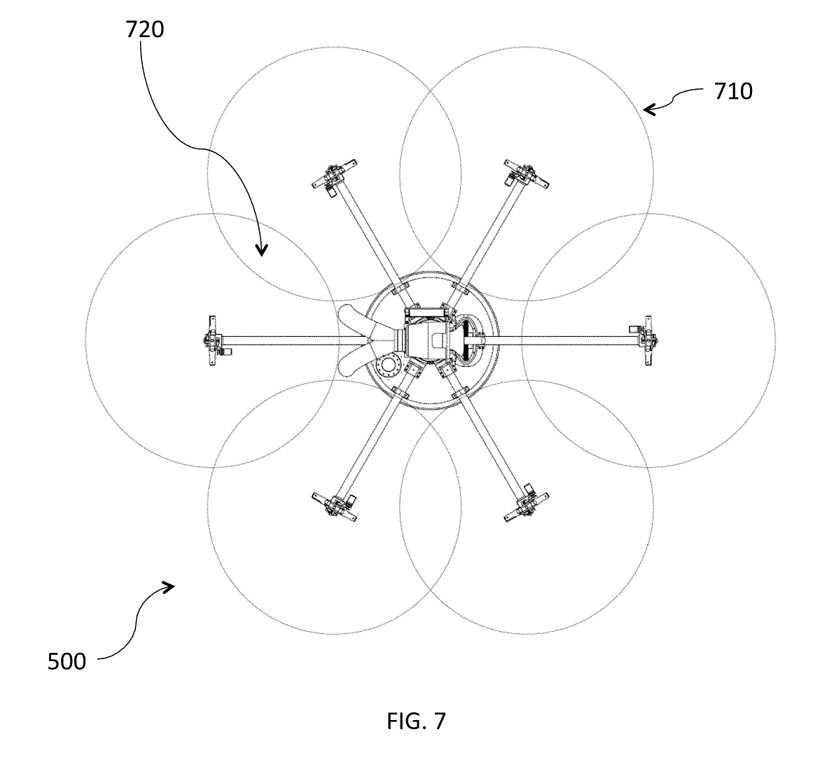

FIG. 7 illustrates a top view of a vehicle according to the present disclosure. Each rotor's lifting area is depicted by rotor disks 710 which are defined by the tips of 820 each rotor blade 810 (not depicted in this Figure). Substantial areas of rotor disk overlap 720, are created by positioning of the rotor hubs 560 and properly sizing the rotor blades.

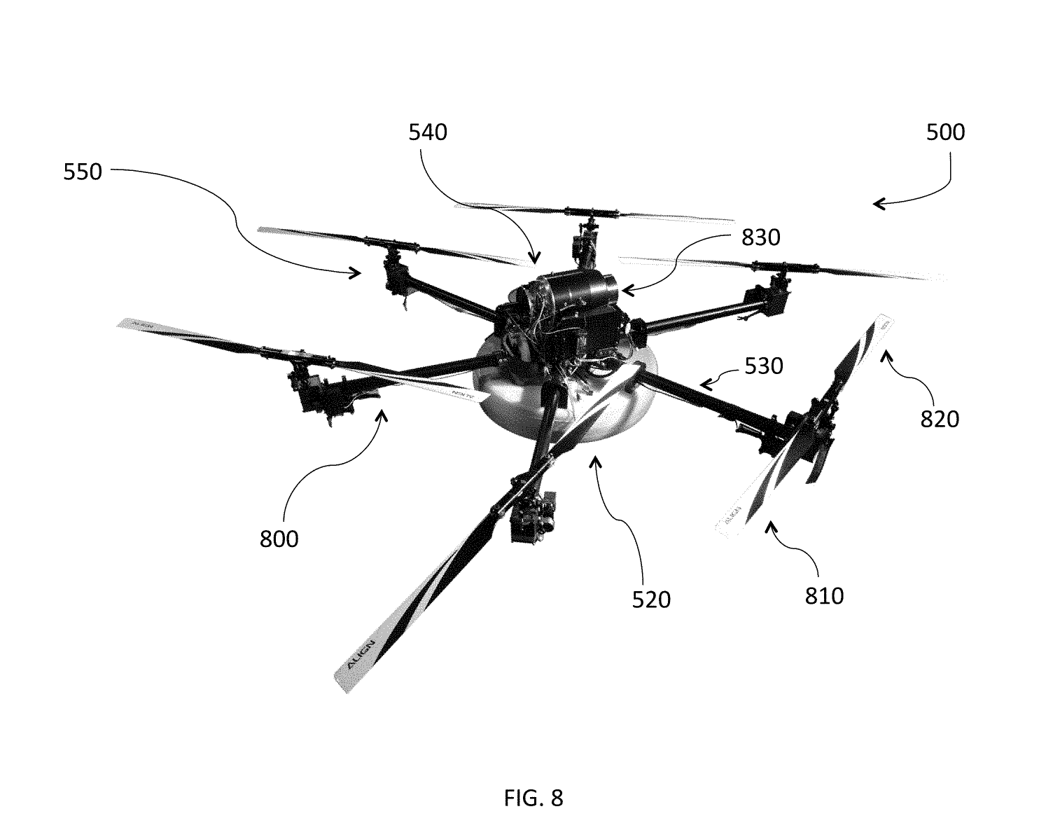

FIG. 8 is a photograph of a vehicle according to the present disclosure. Rotor blades 810 are disposed so that the tips 820 and part of the outboard section of each rotor blade 810 intermesh. Support electronics 830 may include batteries, sensors, computers, amplifiers, transceivers, etc. used for flight control, systems management, navigation, communication functions, etc.

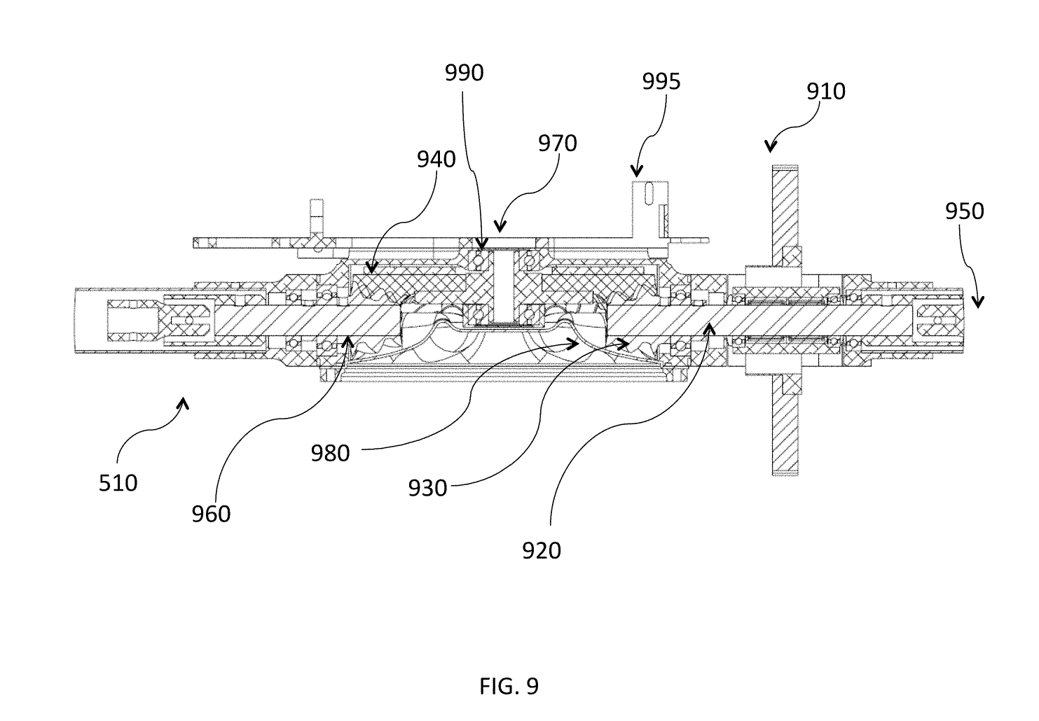

FIG. 9 is a side view of a main gearbox 510 unit according to the present disclosure. Mechanical power is supplied to the main gearbox via power takeoff gear 910, which is connected to an inboard main takeoff shaft 920 that terminates in an input pinion 930. The input pinion 930 drives an optimized helically cut main power-distribution gear 940 rotating about a hollow main transmission shaft 970. A contoured sump cover 980 protects the assembly, and provides a mounting point for the main power-distribution gear 940's bearing 990.

The outboard side of a main takeoff shaft 920 provides a connection to drive a shaft internal to one of the arms 570, to drive the rotor of a single arm. Each of the remaining arms contains a shaft is driven by its own pinion gear 960.

A motor mount 995 may be incorporated as integral to the main gearbox unit.

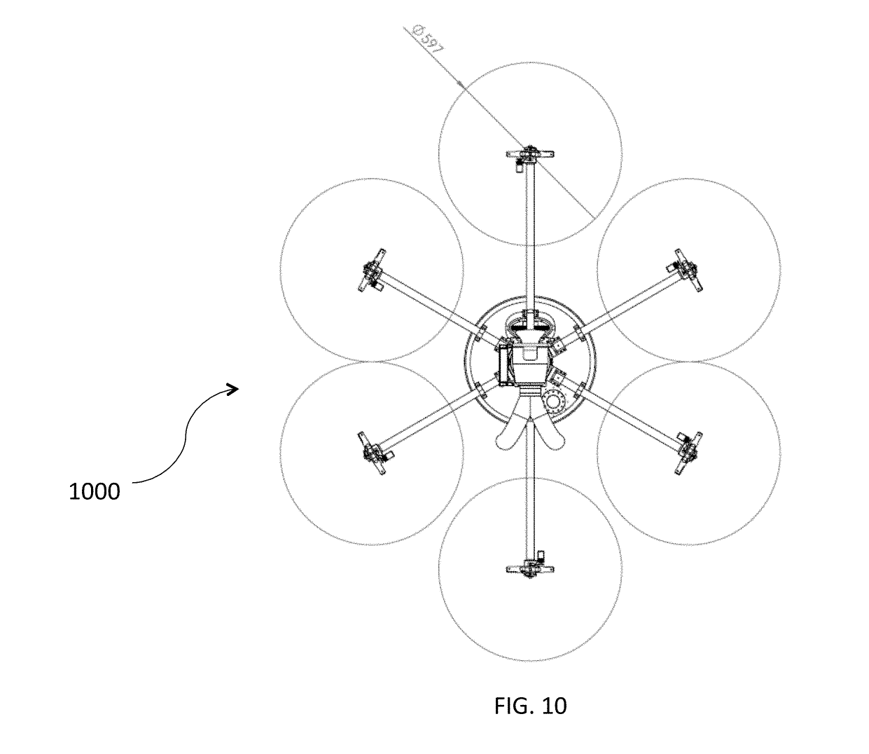

Substantial advantages obtained with this embodiment. For one, all of the rotors operate in the same plane, providing the maximum efficiency possible. Second, because the rotation of each rotor is highly constrained by the low-backlash helical gear and pinion transmission, it is possible to intermesh the rotor disk areas 710 to make the vehicle more compact and to effectively lower the rotor disk loading. The advantage can be quantified by calculating the loading of a non-intermeshing configuration and the intermeshing configuration of the present disclosure. FIG. 10 illustrates a theoretical vehicle configuration 1000 that is similar to exemplary vehicle 500 where the blades 810 have been reduced in length avoid blade overlap. Theoretical vehicle configuration 1000 has 46% higher disk loading than exemplary vehicle 500.

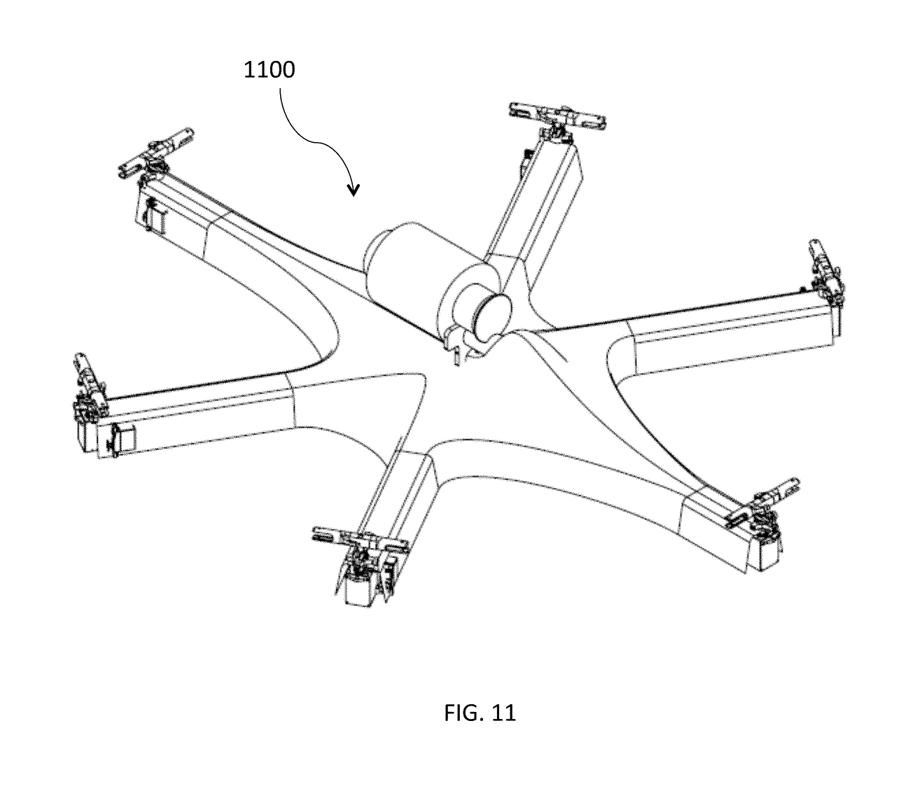

Another embodiment of the present disclosure is illustrated by FIG. 11 providing an isometric view of a monocoque frame vehicle 1100 according to the present disclosure. The monocoque frame vehicle 1100 may be composed of a resin impregnated fiber material such as carbon fiber, and is designed to have a load-bearing skin optimized to minimize weight and provide mounting points for necessary components.

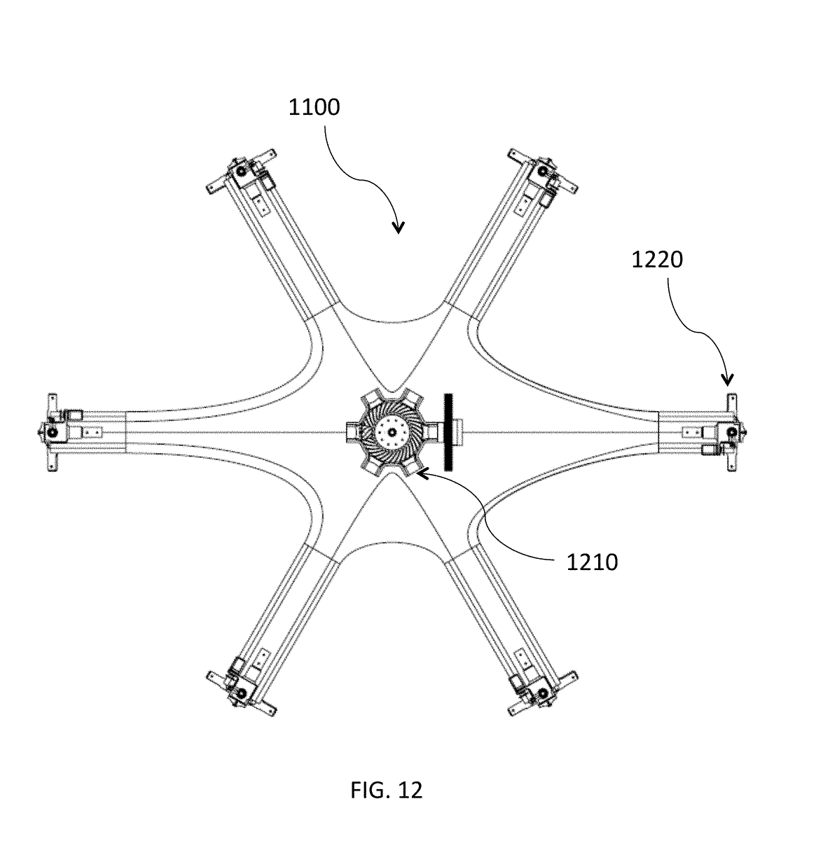

FIG. 12 illustrates a top view of monocoque frame vehicle 1100 which reveals a main rotor gearbox 1210 may perform similar functions to the main gearbox 510 of the multicopter 500 embodiment. Main rotor gearbox 1210 is laminated into the structural skin of monocoque frame vehicle 1100 to reduce weight and component count. Similarly, each rotor gearbox 1220 may perform similar functions as each gearbox assembly 550 of the multicopter 500 embodiment. Each rotor gearbox 1220 is laminated into the structural skin of monocoque frame vehicle 1100 to reduce weight and component count.

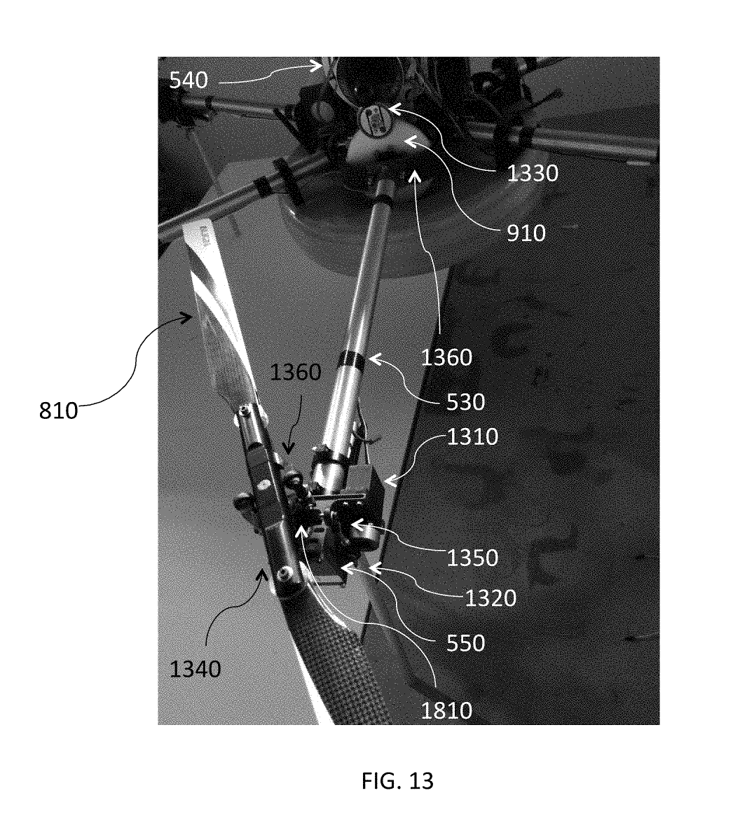

Some additional features of the multicopter 500 embodiment are shown FIG. 13. In particular, FIG. 13 shows a configuration of a power off-take and drive side arm 570 of a multicopter 500 embodiment. A central mechanical power source 540 (gas turbine engine) is shown, whose output shaft is connected via a clutch 1330 to power takeoff gear 910 mounted a shaft pass-through structure 1360 attached to an arm 530 which contains an internal driveshaft 1410 connected to rotor gearbox assembly 550. The gearbox assembly 550 of this particular embodiment, comprises a pitch control servo 1310 driving a pitch control linkage 1350 connected to a variable pitch sliding mechanism 1610 which is then connected to rotor 810's pitch control arms 1360 using linkages 1340.

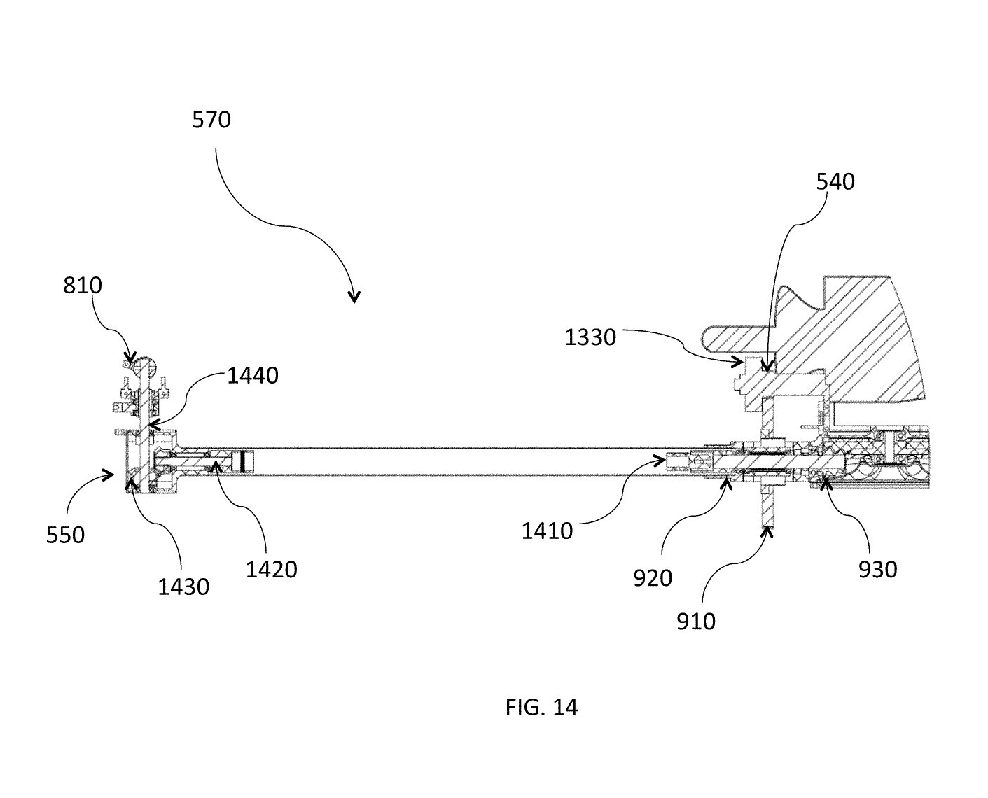

Additional detail of a power off-take and drive side arm 570 is illustrated in FIG. 14 showing the internal configuration of that embodiment. A power take-off gear 910 input pinion 930 via clutch 1330. In addition to allowing for easy starting of a mechanical power source, the clutch 1330 permits aerodynamic forces to back drive the entire rotor system enabling the vehicle to autorotate—an important feature not possible with direct drive motors, or with very heavily loaded rotors even if those rotors are controllable in pitch. As long as battery power is available, control during auto-rotation (through pitch control) is possible. This is in sharp contrast to individually driven rotors that are most typically fixed pitch and where loss of input power means loss of vehicle control.

A main takeoff shaft 920 passes through a power take-off gear 910 and it outboard side drives an internal rotor driveshaft 1410. The internal rotor driveshaft 1410 terminates connected to horizontal rotor shaft 1420 having a bevel gear set 1430 diving each rotor mainshaft 1440. The mainshaft 1440 is directly connected to each rotor 810.

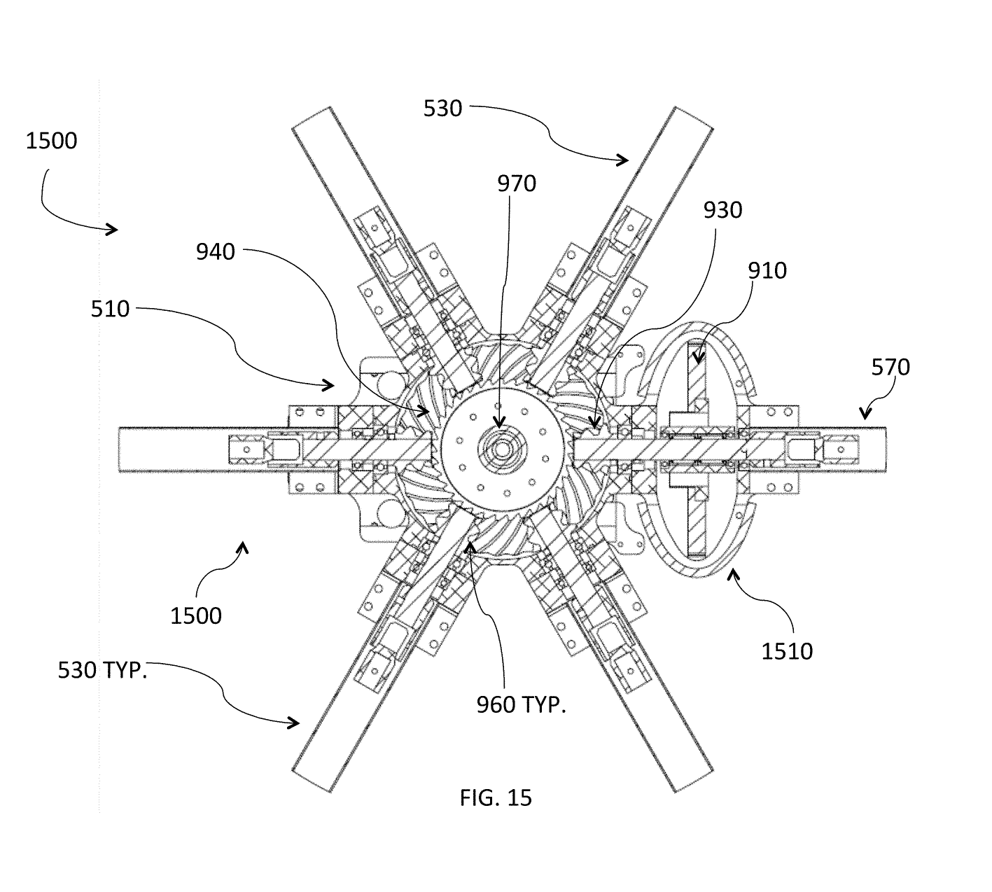

FIG. 15 illustrates the vehicle central gearbox area 1500's structural arrangement of an embodiment of a power take-off and pinion and a main power-distribution gear in relation to passive arms 530 and power off-take and drive side arms 570. The main gearbox 510 receives mechanical power from a main takeoff shaft 920. In this embodiment the difference between passive arms 530 and power off-take and drive side arms 570 is primarily the carry-around structure 1510. The coaxial arrangement of the power takeoff gear 910 relative to an internal driveshaft 1410 allows each drive side arm 570 to provide multiple duties, at least providing input power to the main gearbox 510 and driving one of the rotors 810. Moreover, this arrangement allows higher density of power distribution because no additional entry point is needed for driving the main gearbox 510. In some embodiments there are multiple mechanical power sources 540 transmitting power through more than one drive side arm 570. In such embodiments power redundancy may be provided, or flight regime optimized power sources may be used. Further, this arrangement facilitates the use of hybrid power supply systems, where either a backup electric motor can be an additional power source or an electrical boot motor can be driven by a power source that supplies hotel power for certain periods of time. Alternatively, a battery may be used to provide additional power. In another embodiment, mechanical energy stored by compression or tension may be used to provide short supplemental power that might be used during special maneuvers or emergencies. It should be noted that the precision of the gear and pinion design is essential to allow the intermeshed rotors to function without collisions, whether the rotors are absorbing (initial auto-rotation) or transmitting (powered operation) to whatever fluid medium such a craft is being operating within. Proper material selection and lubrication are also necessary to ensure reliable operation of a main gearbox 510. In further embodiments multiple main gearbox 510 units may be employed. In these configurations, multiple sets of rotors 810 may be disposed with generally coaxial rotors, and configured to counter rotate relative to one another for torque control. In such a configuration, multiple main gearbox 510 units may be disposed with their main drive shafts 940 generally coaxially. In such a configuration overall torque control can be provided in more than one way. In one alternative, multiple power takeoff gears 910 may be configured to intermesh so that each gearbox is driven a fixed rotational ratio (not necessarily one-to-one) to each other. Torque management in this arrangement is provided by varying pitch differentially which changes lift and drag forces. Alternatively, separate power supplies may be used for each main gearbox 510 unit, allowing torque control to be achieved by differential RPM changes.

Other overall geometries with multiple main gearbox 510 units may also be employed in even further embodiments. For example, an arrangement somewhat similar to that of Stingray 500 quad-copter 400 may be advantageous in applications requiring an extended longitudinal axis and the higher power density available (and other advantages) provided according to the present disclosure.

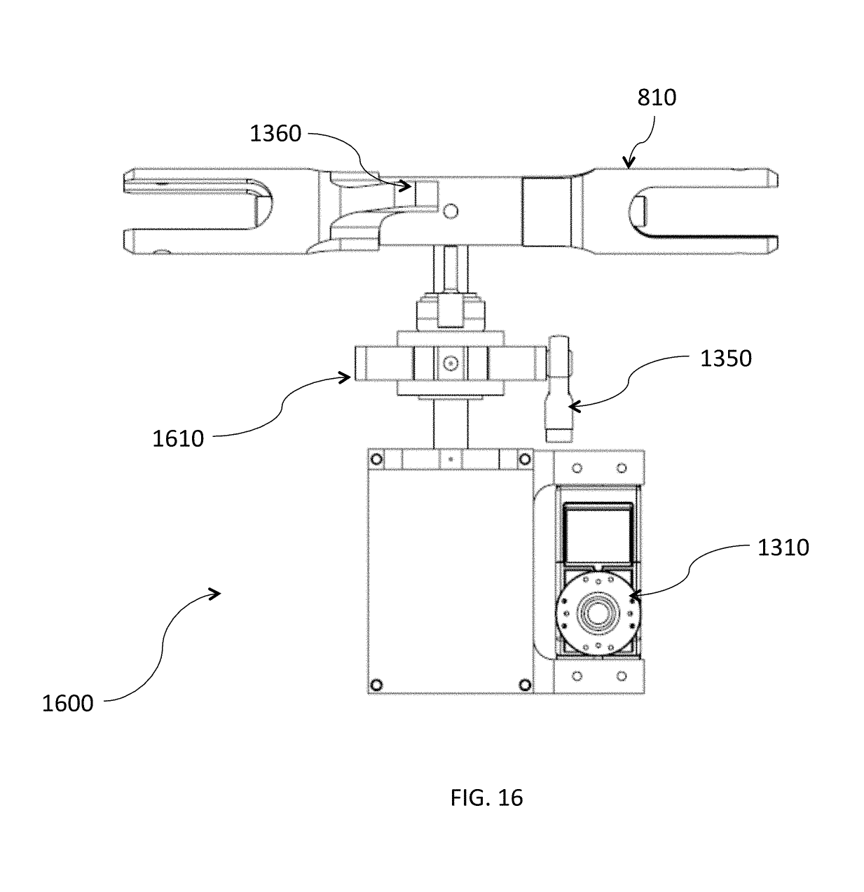

FIG. 16 illustrates an exemplary pitch control arrangement with emphasis on the variable pitch sliding mechanism 1610. Pitch control servo 1310 drives a pitch control linkage 1350 connected to a variable pitch sliding mechanism 1610 which is then connected to rotor 810's pitch control arms 1360.

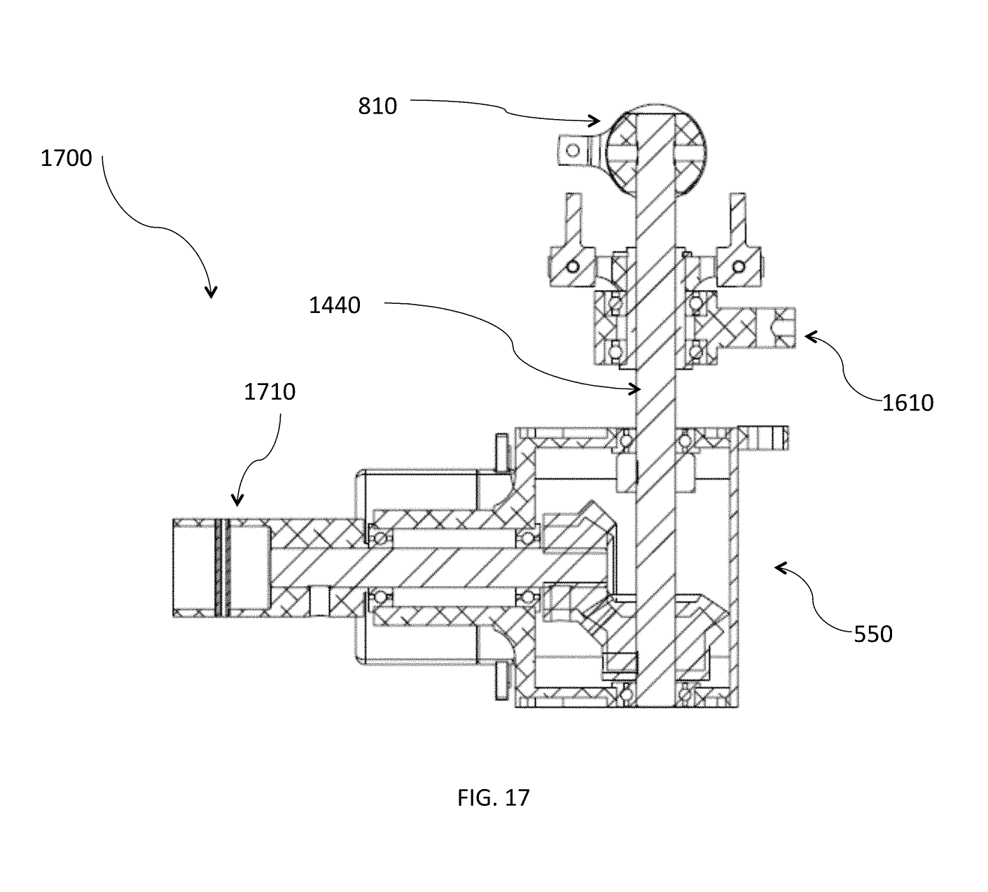

FIG. 17 illustrates an exemplary pitch control sliding mechanism and internal details of a rotor gearbox assembly 550. Horizontal rotor shaft 1420 is configured to attach to the drive input 1710, which is directly connected to a bevel gear set 1430 diving each rotor mainshaft 1440. The mainshaft 1440 is directly connected to each rotor 810. Adjustment of the rotor 810 blade pitch is effected by raising and lowering variable pitch sliding mechanism 1610 up or down rotor mainshaft 1440 in response to force generated by pitch control servo 1310.

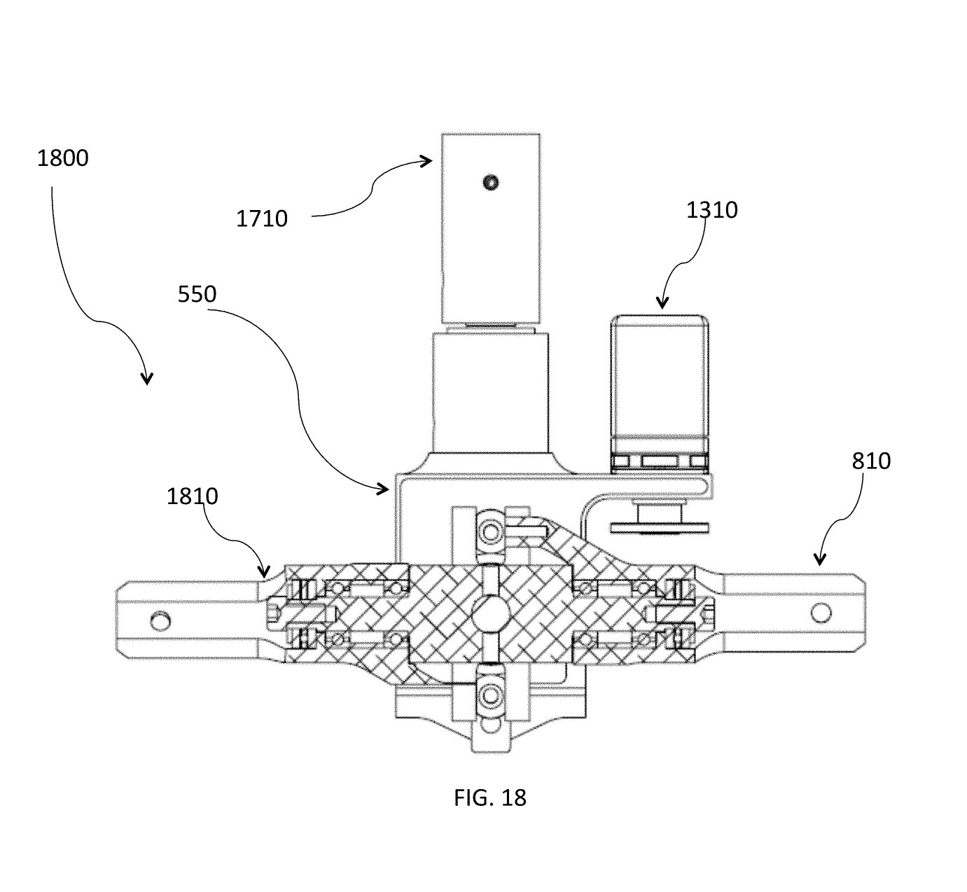

FIG. 18 illustrates an exemplary rotor head 810, which is part of and attached to rotor gearbox assembly 550. In one embodiment the rotor head 810 is a rigid unit. In other embodiments, the rotor head 810 is configured to be a flapping type similar to those used on some helicopters. Pitch control is achieved by allowing rotation using thrust bearing pack 1810, which is configured to properly respond to the centripetal forces generated by blade rotation.

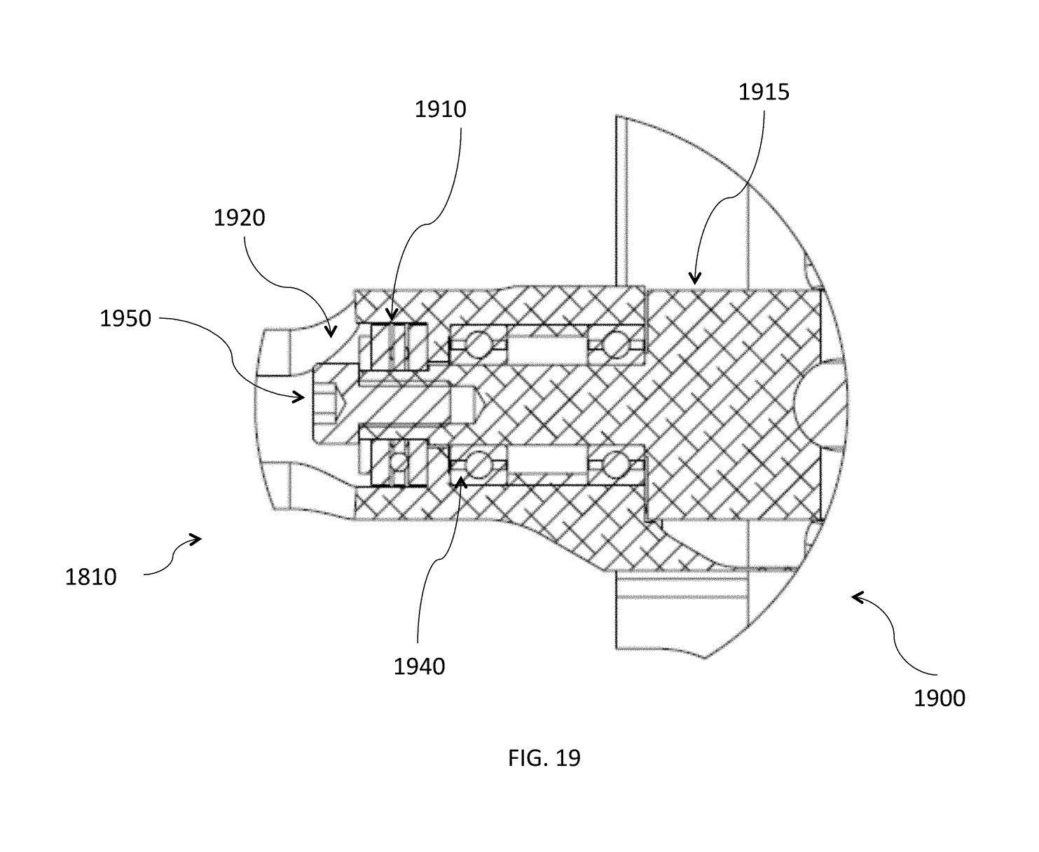

FIG. 19 illustrates more detail of an exemplary thrust bearing pack 1810. A pitch horn collar 1920 is disposed upon stub shaft 1915 via a pair of longitudinal bearings 1940 and a thrust bearing 1910. A blade mounts to the pitch horn collar 1920. The pitch horn collar 1920 is retained on the sub shaft 1915 via retaining screw 1950.

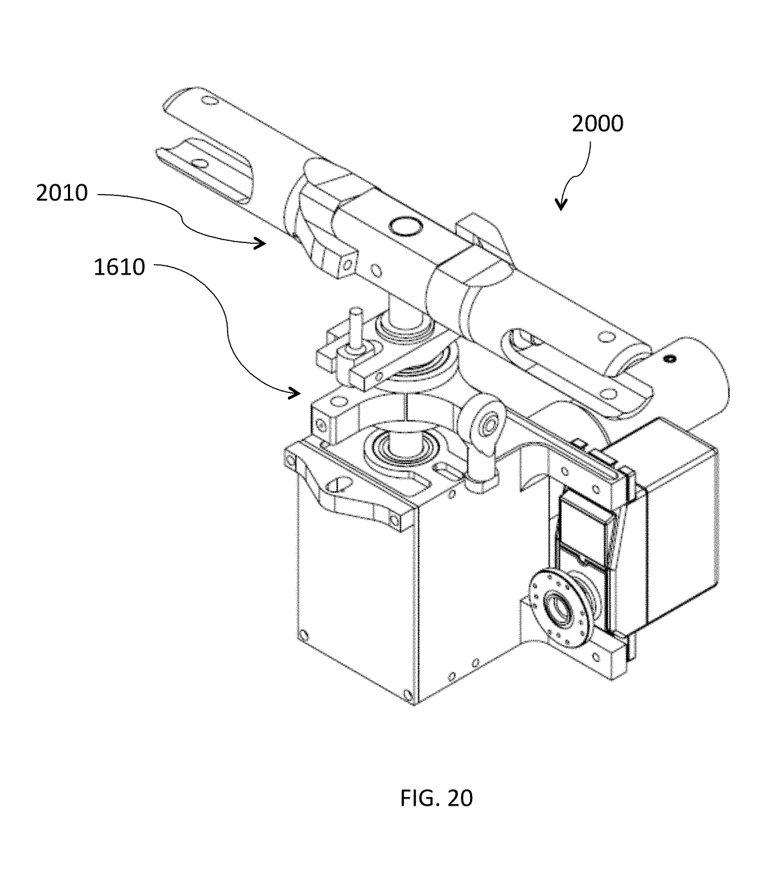

FIG. 20 illustrates an exemplary exchangeable rotor servo subassembly 2000. Variable pitch sliding mechanism 1610 is prevented from rotating around mainshaft 1440 by constraining pin 2010

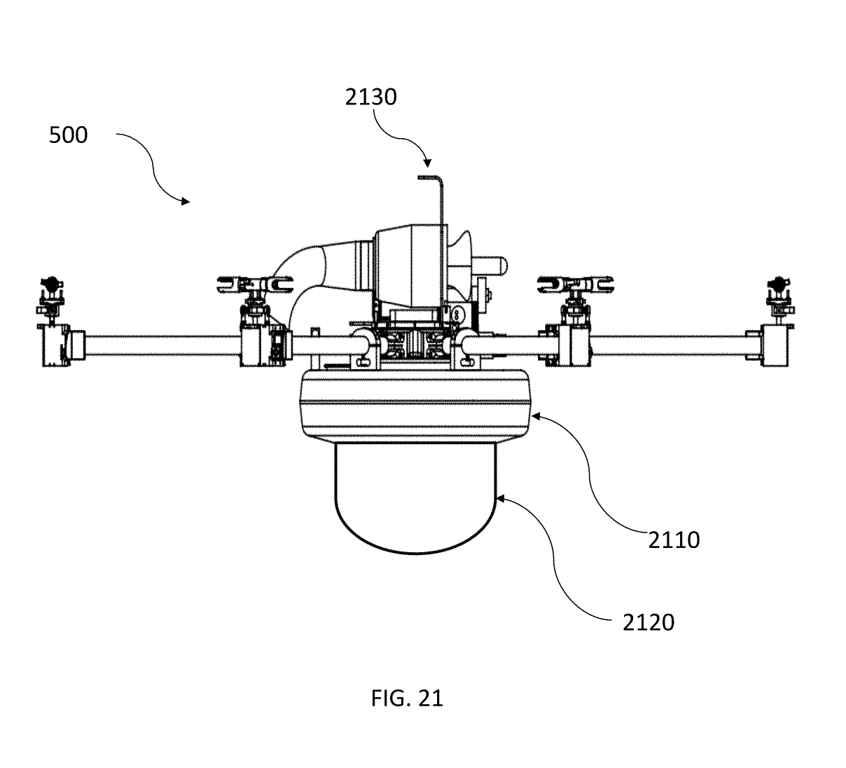

FIG. 21 illustrates a typical payload configuration for a vehicle according to the present disclosure. In this embodiment, an enclosed payload pod 2120 is disposed beneath an exemplary vehicle's 500 fuel tank 2110. Unenclosed payload mounts may be appropriate. Articulated or stabilize mounts for various effectors or sensing payloads may be employed as is known in the art.

In other embodiments, such as the longitudinally extended configuration with offset main gearboxes 510, payloads may be disposed between separated sets of intermeshed disk rotors. Moreover, sensors and payload may be mounted above the rotor plane. For example, an antenna mount bracket 2130 or similar may be used to receive or transmit navigation or telemetry information.

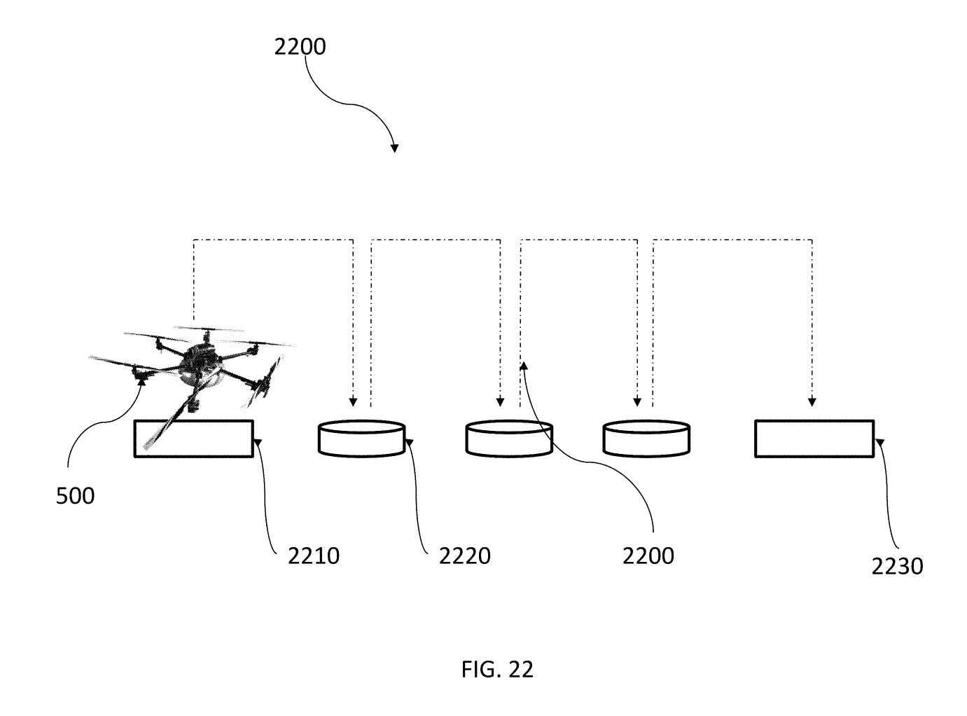

FIG. 22 illustrates a refueling arrangement for a system employing a vehicle according to the present disclosure. A launch station 2210 may be used for initial vehicle 500 dispatch. Intermediate refueling stations 2220 may be employed where vehicle 500 lands manually, semi-autonomously or autonomously to receive additional fuel, and either returns to launch station 2210 or lands at a termination station 2230. Any of stations 2210, 2220 or 2230 may support multiple vehicles 500 and provide fuel, electrical power or battery exchange for revisits. Other embodiments may employ drop-tanks and stations that provide for the pickup of additional drop-tanks.

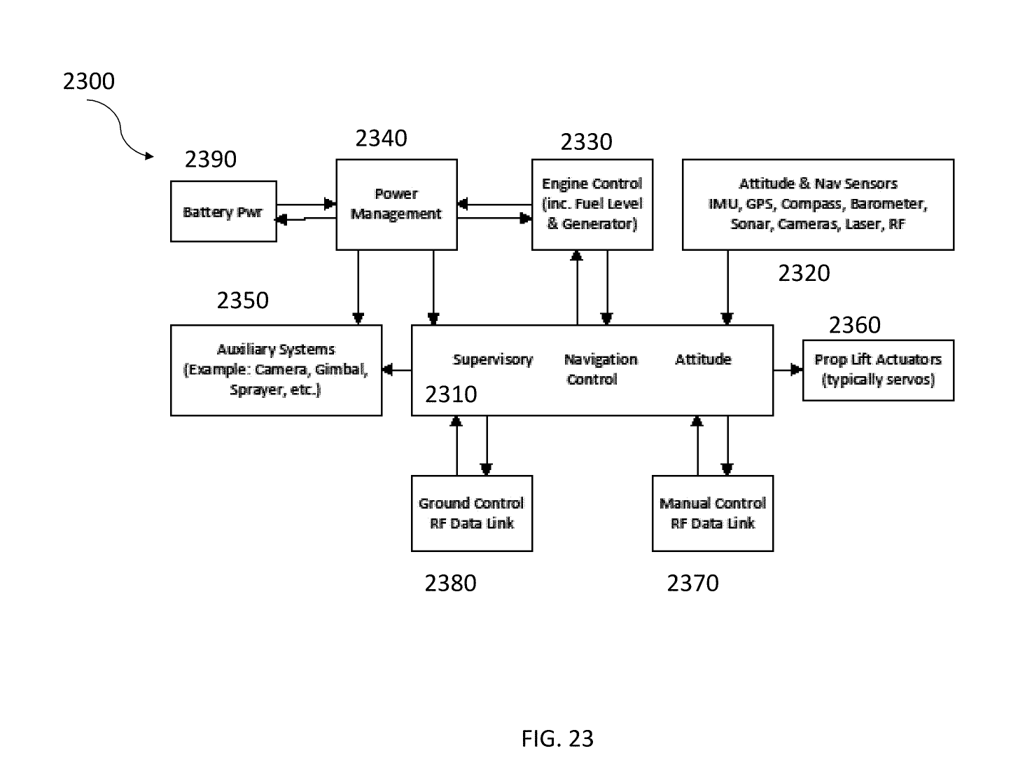

FIG. 23 illustrates a block diagram of exemplary control system 2300 for a vehicle according to the present disclosure, such as may be incorporated in support electronics 830. Electronic controls may provide semi-autonomous operation with stability control, augment manual operation or provide fully autonomous operation. The supervisory functions 2310 integrate attitude control functions and navigation functions. These supervisory functions 2310 may be extended to provide mission specific support by the addition of specialized program code. Sensor/effector input/outputs 2320, take input from a variety of sources which are utilized for control, navigation, communication, data gathering and the like, and data and commands from the supervisory functions 2310 may be received to create responses. Engine control functions 2330 manage and monitor fuel levels, engine temperatures and pressures, and power output from engines whether mechanical or electrical. Power management functions 2340 integrate with engine control functions 2330, with auxiliary systems 2350 and battery power 2390 to supply and regulate power for vehicle or hotel power consumption. Auxiliary systems 2350 such as cameras, effectors such as sprayers or other payload delivery systems, or stabilizing devices for other sensors, such as gimbal, receive inputs and generate outputs to the supervisory functions 2310 and consume power and send data to the power management functions 2340. Actuators 2360, such as prop lift functions typically controlled by servos, receive input from, and provide data to the supervisory functions 2310. Data links 2370 allow for direct manual communication and control via the supervisory functions 2310 via RF, laser or other channels. Ground control data links 2380 provide for the transfer of program or high level control information from a remote station to and from an exemplary vehicle 500, and the receipt of mission related data.

Those familiar with the art will recognize that additional features and systems may be incorporated into the embodiments described, enabled by the high-performance characteristics of the embodiments herein described.

### Definitions

For the purposes herein, lift density means overall lift force divided by the area footprint of the vehicle. The rotor area is the sum of the areas of all of the rotor disks of a multi-rotor vehicle. In a configuration such as that in FIG. 7, the area footprint is substantially less than that of a conventional multi-rotor vehicle, thereby increasing lift density.

Unless otherwise explicitly recited herein, any reference to an electronic signal or an electromagnetic signal (or their equivalents) is to be understood as referring to a non-volatile electronic signal or a non-volatile electromagnetic signal.

Recording the results from an operation or data acquisition, such as for example, recording results at a particular frequency or wavelength, is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use, so that the result can be displayed, recorded to a non-volatile memory, or used in further data processing or analysis.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

1. An apparatus comprising:
a. a body defining a first vertical axis,
b. two or more frame members each having a longitudinal axis and having an inner-end and an outer-end connected to the body at the inner-end and where a first horizontal geometrical plane is generally coincident with the longitudinal axis of each of the two or more frame members and where the first horizontal geometrical plane is generally orthogonal to the first vertical axis,
c. two or more rotary-wings each comprising one or more blades whose rotation defines a first rotational axis which is configurable to be nearly parallel with the first vertical axis and comprising a second rotational axis which is configurable to be approximately parallel first horizontal geometrical plane where:
i. a first of the two or more rotary-wings having a blade-inner-end and a first blade-outer-end rotatably connected by its blade-inner-end to a first transmission is disposed substantially on the outer-end of a first of the two or more frame members,
ii. a second of the two or more rotary-wings having a blade-inner-end and a blade-outer-end rotatably connected by its blade-inner-end to a second transmission is disposed substantially on the outer-end of a second of the two or more frame members,
iii. where each of the first rotational axes is disposed on the opposite side of plane which is coincident with the first vertical axis,
iv. where the direction of rotation of a first of the two or more rotary-wings about its first rotational axis is opposite of that of the second of the two or more rotary-wings about its first rotational axis, and,
v. where the rotational disk defined by the rotation of the blade-outer-end of the first of the two or more rotary-wings is at least partially coincident with rotational disk defined by the rotation of the blade-outer-end of the second of the two or more rotary-wings.

2. The apparatus of claim 1 further comprising one or more power sources each configurable to provide power to at least the two or more rotary-wings.

3. The apparatus of claim 2 where the power is mechanical power.

4. The apparatus of claim 3 where the mechanical power is provided via a shaft.

5. The apparatus of claim 1 comprising at least two sets of the two or more rotary-wings where the each rotational disk is at least partially coincident with more than one other rotational disk.

6. The apparatus of claim 2 where the power source is disposed on or within the body.

7. The apparatus of claim 1 where rotation of a rotary-wing blade is adjustable in operation.

8. A vehicle configured to operate in a fluid media comprising:
a. A central body equipped with a motive source of rotational power,
b. six rotor-arm structures each having an inner-end and an outer-end, and defining a longitudinal axis, are disposed symmetrically about the central body, where the inner-end of each rotor-arm structures is mechanically connected to the central body, and comprises:
i. a mechanical drive for transmitting the rotational power from the inner-end to the outer-end along the longitudinal axis,
ii. a transmission configured to reorient the rotational power at a right angle from its orientation along the longitudinal axis to drive a rotating shaft,
iii. a two-bladed rotary-wing comprising blades having a blade-hub-end and a blade-tip-end is mounted on the rotating shaft with its plane of rotation approximately parallel to the rotor-arm longitudinal axis, where pitch control of each of the two blades of the rotary-wing is provided by a mechanical actuator,
c. where the six-rotors arm structures are positioned such that the disk areas defined by the rotation of each of the blade-tip-ends overlap one another and the direction of rotation of each rotary-wing is the opposite of that of the rotary-wing mounted on the opposite side of the central body.

9. The vehicle of claim 8 where the mechanical drive is a shaft.

10. The vehicle of claim 8 where the mechanical drive is a belt.

11. The vehicle of claim 8 where the pitch of the blades is controlled collectively, cyclically or arbitrarily.

12. The vehicle of claim 8 where the motive source of power is a liquid fueled engine.

13. The vehicle of claim 8 where the motive source of power is an electric motor.
